(19) United States
(12) Patent Application Publication
(10) Pub. No.: US 2005/0212696 A1
(43) Pub. Date: Sep. 29, 2005

(54) Reat-time WaveSmooth™ error mitigation for Global Navigation Satellite Systems

(76) Inventors: Chris Gregory Bartone, Athens, OH (US); Yujie Zhang, Athens, OH (US)

Correspondence Address: Chris Gregory Bartone, P.O. Box 5601, Athens, OH, 45701, US

(21) Appl. No.: 11/087,022

(22) Filed: Mar. 21, 2005

Related U.S. Application Data
(60) Provisional application No. 60/556,067, filed on Mar. 25, 2004.

(51) Int. Cl. G01S 5/14

(52) U.S. Cl. 342/357.02

(57) ABSTRACT

WaveSmooth™ is a technique to mitigate inherent measurement error for GNSS signals. The WaveSmooth™ technique can be applied for single-frequency or multi-frequency GNSS users. For single-frequency GNSS users, WaveSmooth™ enables smoothing of GNSS measurements, in real-time using wavelets without introducing significant ionosphere divergence. For multi-frequency GNSS users, the WaveSmooth™ technique effectively mitigates multipath error in a real-time fashion. The WaveSmooth™ techniques utilizes wavelet aided methods and operate on the GNSS Code minus Carrier (CmC) signal to mitigate inherent GNSS measurement errors in a real-time fashion to improve the performance of these GNSSs. The WaveSmooth™ error mitigated pseudorange measurement can be used, along with the original carrier phase measurement for a high performance user solution.

### CROSS-REFERENCE TO RELATED APPLICATIONS

A provisional patent was submitted by the investors and received by the USPO with application No. 60/556,067, filing date Mar. 25, 2004 and confirmation number 5404, with title “Real-time WaveSmooth error mitigation for global navigation satellite systems”.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF INVENTION

The invention relates generally to the mitigation of errors inherent in spread-spectrum signals, and more particularly to a wavelet-based error mitigation technique directly applicable to Global Navigation Satellite Systems (GNSS) (e.g., GPS, Galileo, GLONASS, etc). Additionally, WaveSmooth™ can be integrated into GNSS software processing to improve performance. The processing can be implemented in new GNSS or existing receiver configurations. The WaveSmooth™ technique can be implemented in real-time or in a post-processing fashion.

GNSS architectures are typically multi-frequency and can be implemented by the user as a single, dual, or multi-frequency fashion to calculate the user state (i.e., position, velocity, and time). Multiple frequencies are used to help with ionosphere error mitigation as well as interference immunity. Multiple codes are implemented to provide different levels of performance/service. Modulation encodes data and codes onto the carrier frequency for transmission from the Space Vehicle (SV) to the mobile user. GNSS measurements may be modeled as the following for the code and carrier phase respectively between the user and a particular SV; the text book by Misra, P. and Enge, P., Global Position System Signals, Measurements, and Performance, Ganga-Jamuna Press, Lincoln, Mass., 2001, pp. 125-128 detail on these signal models used for GPS.
ρ_{q,k}=rₖ+δt^{SV}+bᵤ+I_{q,k}+Tₖ+M_{q,ρ,k}+ε_{q,ρ,k}
and
φ_{q,k}=rₖ+δt^{SV}+bᵤ−I_{q,k}+Tₖ+M_{q,φ,k}+ε_{q,φ,k}+N_{q,φ,k} (1)
where:
ρ_{q,k}: pseudorange measurement at frequency q, and time epoch k[m]
rₖ: true range at frequency q, and time epoch k[m]
δt^{SV}: space vehicle clock error [m]
bᵤ: user receiver clock bias error [m]
lₖ: ionosphere error at frequency q, and at time epoch k[m]
Tₖ: ionosphere error at time epoch k[m]
M_{q,ρ,k}: code phase multipath error at frequency q, and at time epoch k[m]
ε_{q,ρ,k}: code phase error at frequency q, and at time epoch k[m]
φ_{q,k}: carrier phase measurement at frequency q, and time epoch k[m]
M_{q,φ,k}: carrier phase multipath error at frequency q, and at time epoch k[m]
ε_{q,φ,k}: carrier phase error at frequency q, and at time epoch k[m]
λ_{q}: carrier phase wavelength at frequency q[m]
N_{q,φ,k}: carrier phase ambiguity related bias at frequency q, and at time epoch k[m]
q: GNSS center frequency for signal of interest [Hz]
k: time epoch [unitless]

Multi-frequency GNSS measurements can be used to remove the effects from the ionosphere. Dual-frequency GPS measurements are formed to produce ionosphere free (iono-free) code and carrier phase measurement as Equation (2), in accordance with the textbook by Misra, P. and Enge, P., Global Position System Signals, Measurements, and Performance, Ganga-Jamuna Press, Lincoln, Mass., 2001, pp. 141-142 for GPS.

$${ρ}_{k}^{*} = \frac{{f}_{L 1}^{2}}{{f}_{L 1}^{2} - {f}_{L 2}^{2}} {ρ}_{L 1 , k} - \frac{{f}_{L 2}^{2}}{{f}_{L 1}^{2} - {f}_{L 2}^{2}} {ρ}_{L 2 , k} and \\ {ϕ}_{k}^{*} = \frac{{f}_{L 1}^{2}}{{f}_{L 1}^{2} - {f}_{L 2}^{2}} {ϕ}_{L 1 , k} - \frac{{f}_{L 2}^{2}}{{f}_{L 1}^{2} - {f}_{L 2}^{2}} {ϕ}_{L 2 , k} \qquad ( 2 )$$

where
f_{L1}: GPS L1 frequency 1575.42 MHz
f_{L2}: GPS L2 frequency 1227.60 MHz
*: iono-free
η: code measurement [m]
φ: carrier phase measurement [m]

Using the code and carrier phase models presented in Equation (1), a Code minus Carrier (CmC) signal can be formed for single-frequency GNSS users in accordance with Equation (3) at every time epoch k, (for each space vehicle (SV)).

$$\begin{matrix}{CmC}_{biased , k} = {ρ}_{q , k} - {ϕ}_{q , k} \\ = 2 {I}_{q , k} - {N}_{ϕ , k} + {M}_{q , ρ , k} - {M}_{q , ϕ , k} + {ɛ}_{q , ρ , k} - {ɛ}_{q , ϕ , k}\end{matrix} \qquad ( 3 )$$

where:
CmC_{biased,k}=biased Code minus Carrier residual at frequency q, and at time epoch k[m].

In a similar fashion the CmC is formed, using Equation (2), for dual-frequency GNSS users in accordance with Equation (4) at every time epoch k, (for each space vehicle (SV)).

$$\begin{matrix}{CmC}_{biased , k}^{*} = {ρ}_{k}^{*} - {ϕ}_{k}^{*} \\ = - {N}_{ϕ , k} + {M}_{ρ , k} - {M}_{ϕ , k} + {ɛ}_{ρ , k} - {ɛ}_{ϕ , k}\end{matrix} \qquad ( 4 )$$

where:
CmC_{biased}: iono-free biased Code minus Carrier residual at time epoch k[m]
N_{φ,k}: iono-free carrier phase ambiguity related bias component [m]
M_{ρ,k}: iono-free code phase multipath [m]
M_{φ,k}: iono-free carrier phase multipath [m]
ε_{ρ,k}: other iono-free code phase error terms [m]
ε_{φ,k}: other iono-free carrier phase error terms [m]

Equations (3) and (4) contain a carrier phase integer ambiguity, multipath, and receiver noise error terms associated with the code and carrier measurements. Typically, the CmC signal has been used to assess error variations in a post-processing fashion, where the mean value is subtracted from the data segment of interest.

Error mitigation techniques for GNSS can be classified into the time domain and the frequency domain. The time domain filter provides a fixed time resolution and no explicit information about frequency, while the frequency domain processing approach provides a fixed frequency resolution and no direct localization in time.

For time domain processing, the Carrier Smoothed Code (CsC) (i.e., Hatch filter), and the Kalman filter are generally utilized to smooth the code measurement and substantially reduce the high frequency noise error terms. CsC smoothing techniques have been implemented for various local area augmentation systems to reduce receiver noise, which may include relatively high rate multipath error. An example of this implementation of CsC is for the Federal Aviation Administration development of the Local Area Augmentation System, where CsC details can be found in the RTCA Minimum Aviation System Performance Standards for the Local Area Augmentation System (LAAS), DO-253A, RTCA Inc., 1998, pp. 40-41, http://www.rtca.orq. While the errors of high frequency such as receiver noise and some multipath can be mitigated through this CsC technique, low frequency errors such as ionosphere and low rate multipath can accumulate a bias at the output of this smoothing. For a single-frequency GPS user, the ionosphere divergence occurs at a typical rate of 0.018 m/s through the CsC processing, with a 100 s time constant. This typical rate is documented for the LAAS in RTCA Minimum Operational Performance Standards for GPS Local Area Augmentation System Airborne Equipment, DO-245, RTCA Inc., 2001, pp. 30, http://www.rtca.org. Higher rate divergence can occur during periods of high ionosphere activity which can affect system performance. Consequently, the 100 s smoothing time constant encompasses a trade off between high frequency error mitigation (receiver noise and some multipath mitigation) and low frequency error bias accumulation (largely, ionosphere divergence). For a typical ground based GNSS location, based on Braasch, M. S., and Van Dierendonck A. J., GPS Receiver Architectures and Measurements, Proceedings of the IEEE, Vol. 87, No 1, January 1999, pp. 48-64, a multipath model is implemented in Dickman, J., Bartone, C., Zhang, Y., and Thornburg, B., “Characterization and Performance of a Prototype Wideband Airport Pseudolite Multipath Limiting Antenna for the Local Area Augmentation System”, Institute of Navigation, National Technical Meeting, Jan. 22-24, 2003, Anaheim, Calif., pp. 783-793. The multipath model predicts that the multipath error fading frequency ranges from about zero to 0.005 Hz, and is typically less than 0.01 Hz; these multipath fading frequency rates are documented in a paper by Zhang. Y., Bartone, C. G., “Multipath Mitigation in the Frequency Domain,” Proceedings of IEEE Position Location And Navigation Symposium 2004, Sep. 9-12, 2004, Monterey, Calif., ISBN 0-7803-8417-2, © 2004 IEEE, pg. 486-495. Thus, CsC, with a 100 s time constant, cannot mitigate the majority of the multipath error, which changes at a relative slow rate, with respect to the 100 s smoothing time constant.

The frequency domain processing technique can effectively be used for multipath mitigation when the multipath fading frequency can be well predicted, as documented in a paper by Zhang. Y., Bartone, C. G., “Multipath Mitigation in the Frequency Domain,” Proceedings of IEEE Position Location And Navigation Symposium 2004, Sep. 9-12, 2004, Monterey, Calif., ISBN 0-7803-8417-2, © 2004 IEEE, pg. 486-495. This technique implements a Fast Fourier Transform (FFT) where the block size needs to be comparable to the multipath cycle targeted for removal; 20-60% real-time and 50-70% post-process multipath mitigation was achieved for FFT block sizes on the order of 256 and 512. The block size needs to be carefully select in order to leverage the tradeoff between the mitigation effect and the overlapping frequency spectrum of multipath and other measurement error components, which may not be desired for removal using the frequency domain approach. This technique is believed to be well suited for the applications where the multipath fading frequency can be well predicted which is especially true for static ground-based applications; the technique can be applied for mobile user applications where this multipath frequency estimation can occur using spectral estimation techniques on the CmC data from the code and carrier measurements.

The reduction of multipath has become an essential part of any high precise GNSS architecture. Both hardware, mainly in terms of radio frequency (RF), and software approaches have been pursued to mitigate multipath. Various RF approaches come in the form of antenna design as documented in the following papers: Thornberg, B., Thornberg, D., DiBenedetto, M, Braasch, M., van Graas, F, Bartone, C., “The LAAS Integrated Multipath Limiting Antenna (IMLA)”, NAVIGATION Journal, of The Institute of Navigation, Vol. 50, No. 2, Summer 2003, pp. 117-130; and, Brown, A., “Multipath Rejection Through Spatial Processing”, Proceedings of ION GPS-2000, September, 2000, Salt Lake City, Utah, pp. 2330-2337; and Kunysz, W., “A Novel GPS Survey Antenna”, Institute of Navigation, National Technical Meeting, Jan. 26-28, 2000, Anaheim, Calif., pp. 698-705; and Dickman, J., Bartone, C., Zhang, Y., and Thornburg, B., “Characterization and Performance of a Prototype Wideband Airport Pseudolite Multipath Limiting Antenna for the Local Area Augmentation System”, Institute of Navigation, National Technical Meeting, Jan. 22-24, 2003, Anaheim, Calif., pp. 783-793. These RF approaches attempt to minimize the net effect of the undesired multipath signal while providing sufficient gain to the desired signal of interest. Various software approaches have been pursued in the form of advanced receiver design as documented by: A. J. Van Dierendonck, Pat Fenton, and Tom Ford, Theory And Performance Of Narrow Correlator Spacing in a GPS Receiver, NAVIGATION Journal of the Institute of Navigation, Vol. 39 No. 3, 1992, pp. 265-284; and Shallberg, K., et al., “WAAS Measurement Processing, Reducing the Effects of Multipath”, Proceedings of ION GPS 2001, Sep. 11-14, 2001, Salt Lake City, Utah, pp. 2334-2340; and L. R. Weill, “High-Performance Multipath Mitigation Using the Synergy of Composite GPS Signals”, Proceedings of ION GPS 2003, Sep. 9-12, 2003, Portland, Oreg., pp. 829-840. These software approaches are at the system, receiver correlator, or post-detection point.

For ground based reference station applications, low frequency multipath can be mitigated using a RF approach by implementing advanced antenna designs where the low rate ground multipath can be mitigated with added cost and complexity; an example of this implementation can be found the paper by Thornberg, B., Thornberg, D., DiBenedetto, M, Braasch, M., van Graas, F, Bartone, C., “The LAAS Integrated Multipath Limiting Antenna (IMLA)”, NAVIGATION Journal, of The Institute of Navigation, Vol. 50, No. 2, Summer 2003, pp. 117-130. Various software multipath mitigation approaches can be classified into time domain processing and frequency domain processing techniques. A typical time domain processing technique is carrier smoothed code (CsC), i.e., Hatch filter. The CsC approach will typically limit the smoothing time (e.g., 100 s) for single frequency users, and hence has limited value to remove low rate multipath. Another time domain processing technique is the code noise and multipath (CNMP) algorithm; the paper by Shallberg, K., et al., “WAAS Measurement Processing, Reducing the Effects of Multipath”, Proceedings of ION GPS 2001, Sep. 11-14, 2001, Salt Lake City, Utah, pp. 2334-2340, provided additional detail on the CNMP. The CNMP algorithm utilizes dual frequency code and carrier phase measurements to form a multipath corrected code measurement. However, the CNMP ionosphere free measurement (with the carrier phase ambiguity bias included), turns out to be essentially the same as the conventional ionosphere free carrier phase measurement. Therefore, the CNMP algorithm is of limited value in multipath mitigation, when both code and carrier measurements are desired for use in the user solution. Another time domain processing technique is the optimum synergy of modernized GPS signal using maximum likelihood (ML) estimator as documented in the paper by L. R. Weill, “High-Performance Multipath Mitigation Using the Synergy of Composite GPS Signals”, Proceedings of ION GPS 2003, Sep. 9-12, 2003, Portland, Oreg., pp. 829-840. Significant multipath mitigation has been proved based on the Cramer-Rao bound theory. However, this technique is fairly computationally complicated and not done in real-time.

Wavelet signal processing techniques encompasses spectrogram analysis to provide a time resolution representation of the signals, and offers the ability to analyze these signals at different frequencies and to localize them in time. Additional detail on the theory of wavelet signal processing can be found in Strang G., Nguyen T., Wavelets and filter banks, Wellesley-Cambridge Press, 1996, and Albert Cohen, Robert D. Ryan, Wavelets and Multiscale Signal Processing, Chapman & Hall Press, 1995.

Wavelet based signal processing methods have been applied to GPS for error mitigation and have typically operated on either the pseudorange or double difference (DD) measurements. (DD measurements are formed in a differential GPS (DGPS) architecture between a reference and user station.) Papers by Xuan, F., Rizos, C., “The Applications of Wavelets to GPS Signal Processing”, ION GPS 1997, Sep. 16-19, 1997, pp. 697-702, and Xia, L., Liu, J., “Approach for Multipath Reduction Using Wavelet Algorithm”, ION GPS 2001, Sep. 11-14, 2001, Salt Lake City, Utah, pg 2134-2143, and Menezes de Souza E., Multipath Reduction from GPS Double Differences using Wavelets: How far can we go?, ION GNSS 2004, Sep. 21-24, 2004, pp. 2563-2571.

### BRIEF SUMMARY OF THE INVENTION

In this patent, a new technique WaveSmooth™ is introduced for error mitigation in GNSS architectures. The WaveSmooth™ technique included in this patent is applicable to two main classes of GNSS architectures; 1) single-frequency error mitigation, and 2) multi-frequency error mitigation. For single-frequency GNSS architectures error mitigation comes largely in the form of pseudorange error mitigation. For multi-frequency GNSS architectures (e.g., dual-frequency GPS) error mitigation largely comes in the form of multipath mitigation. GPS is used to illustrate the WaveSmooth™ technique.

In this patent, a new WaveSmooth™ code processing technique is presented here to enable real-time smoothing of single-frequency GNSS measurements, using wavelets. The WaveSmooth™ technique effectively remove code multipath error in a real-time fashion for multi-frequency GNSS users. This WaveSmooth™ technique effectively removes the receiver noise error and major multipath error in a real-time fashion, using wavelet transforms, where n calculations are required for a given block length of n. (These calculations are less than the nlog₂n need to perform the FFT as described in Phillips, W. J. “Wavelets and Filter Banks Course Notes”, Apr. 3, 2004, http://www.engmath.dal.ca/courses/engm6610/notes/notes.html, date visited Aug. 12, 2004.) The WaveSmooth™ technique is uniquely different from previous wavelet techniques that operate on the GPS double differences such as paper by: Xuan, F., Rizos, C., “The Applications of Wavelets to GPS Signal Processing”, ION GPS 1997, Sep. 16-19, 1997, pg 1385-1388, and Xia, L., Liu, J., “Approach for Multipath Reduction Using Wavelet Algorithm”, ION GPS 2001, Sep. 11-14, 2001, Salt Lake City, Utah, pg 2134-2143, and Menezes de Souza E., Multipath Reduction from GPS Double Differences using Wavelets: How far can we go?, ION GNSS 2004, Sep. 21-24, 2004, pp. 2563-2571. The WaveSmooth™ operates on the GNSS CmC measurement to form a real-time estimate of the error targeted for removal. This error estimate is applied to the original code phase measurement, to enhance single-frequency or dual-frequency measurements that are implemented in a standalone or differential GNSS architecture, respectively. These WaveSmooth™ techniques and enhancements have been documented for single-frequency users by Bartone, C., Zhang. Y., “A Real-Time Hybrid-Domain WaveSmooth™ Code Processing Using Wavelets”, Proceedings of ION GNSS 2004, Sep. 21-24, 2004, Long Beach, Calif., pp. 436-446, and for dual-frequency users by Zhang. Y., Bartone, C., “Real-time Multipath Mitigation with WaveSmooth™ Technique using Wavelets”, Proceedings of ION GNSS 2004, Sep. 21-24, 2004, Long Beach, Calif., pp. 1181-1194.

### BRIEF DESCRIPTION OF THE SEVERAL VIEWS OF THE DRAWING

Not Applicable.

### DETAILED DESCRIPTION OF THE INVENTION

In this patent, the WaveSmooth™ technique is useful for error mitigation in various GNSS architectures. For single-frequency GNSS architectures error mitigation largely comes in the form of smoothed pseudoranges with some multipath mitigation. For multi-frequency GNSS architectures (e.g., dual-frequency GPS) error mitigation largely comes in the form of multipath mitigation with some smoothing effects. To illustrate the details of the WaveSmooth™ technique, single-frequency GPS measurements and dual-frequency (i.e., ionosphere free) GPS measurements will be used as a test case to illustrate the WaveSmooth™ technique.

The WaveSmooth™ technique utilizes spectrogram analysis to decompose the GNSS signal in time and frequency using wavelet transform, and offers the unique ability to analyze the error characteristics, including multipath at different frequencies and to localize them in time. This is because the wavelet elements are the waveforms indexed by three naturally interpreted parameters: 1) position, 2) scale in the wavelet decomposition, and 3) frequency. Therefore the wavelet transform offers advantages over its frequency domain counterpart (e.g., Fourier analysis) and time domain counterpart (e.g., CsC and Kalman filter). Consequently, WaveSmooth™ provide the option to discard the unwanted component such as multipath and receiver noise and keep the low frequency ionosphere component, which could be removed in later processing (i.e., through differential GPS (DGPS)). The technique was developed and implemented for modernized GNSS signal to provide a real-time error correction for GNSS signals.

WaveSmooth™ real-time multipath mitigation technique will now be described in three major steps where the inputs are the code and carrier phase measurements from time epoch k−τ+1 to time epoch k. The output is the real-time multipath mitigated code measurements at current time epoch k. The process can be classified into three steps.

Step 1 Unbiased CmC Residual Formation. Firstly, the ionosphere error can be not performed at this stage for a single-frequency GNSS user, or removed in a multi-frequency GNSS receiver system (e.g., by forming ionosphere free measurements using Equation (2); additionally, the ionosphere error can be removed by other techniques. (The reason not to remove the ionosphere error at this point, may be selected by the user for example, a short baseline, application.) With the CmC formed for single-frequency GNSS users as in Equation (3), or for multi-frequency GNSS users as in Equation (4) for every epoch. The bias term in the CmC (carrier integer ambiguity and initial bias errors) are removed in order to get a closer look at any dominate error that might be present. The bias term is calculated as Equation (5) in the real-time processing, which is the mean of the CmC from epoch k−τ+1 to epoch k. For a “small” smoothing window size τ, (i.e. less than a multipath cycle) the bias estimate will be less accurate. For a “large” smoothing window size τ, (i.e., comparable to a multiple multipath cycle), the average bias term in Equation (5) will represents more precisely the true constant bias.

$$\overline{{CMC}_{biased , k}} {\vert}_{τ} = \frac{{\sum }_{j = k - τ + 1}^{k} {CMC}_{biased , j}}{τ} \qquad ( 5 )$$

This average CmC constant bias, averaged over some smoothing window τ epochs, as expressed in Equation (5), is removed at each time epoch k from the biased CmC residual, expressed in Equation (3) or (4) to form an unbiased CmC at each time epoch k, as shown in Equation (6) for single-frequency users, and Equation (7) for multi-frequency users, respectively.

$$\begin{matrix}{CmC}_{unbiased , k} = {CmC}_{biased , k} - \overline{{CmC}_{biased , k}} {\vert}_{τ} \\ = 2 {I}_{k} + {M}_{ρ , k} - {M}_{ϕ , k} + {ɛ}_{ρ , k} - {ɛ}_{ϕ , k} + {ɛ}_{u}\end{matrix} \qquad ( 6 )$$

where:
εᵤ=additional error introduced in the unbiasing of the CmC

$$\begin{matrix}{CmC}_{unbiased , k} = {CmC}_{biased , k} - \overline{{CMC}_{biased , k}} {\vert}_{τ} \\ = {M}_{ρ , k} - {M}_{ϕ , k} + {ɛ}_{ρ , k} - {ɛ}_{ϕ , k} + {ɛ}_{u}\end{matrix} \qquad ( 7 )$$

As shown in Equations (6) and (7), an additional error term (epsilon with subscript “u”) can be introduced when a small τ is used to form the unbiased CmC residual; this term represents an additional error term that is introduced in the unbiasing procedure. This term will diminish when a large τ is applied or a longer previous data are available for CmC bias estimate. This unbiased CmC signal, shown in Equation (6) or (7) will be used as the basis for the error estimation for single-frequency and multi-frequency GNSS architectures, respectively.

Step 2 Error Estimation. Wavelet analysis techniques are applied to the unbiased CmC residual, shown in Equation (3) to identify various frequency components of the error terms and localize them in time. The unbiased CmC signal is decomposed into different levels of frequency component via wavelet analysis techniques. Since the wavelet processing introduces negligible recursive delay lag, the wavelet processing time constant window (i.e., block length) can be theoretically selected relatively very long. For computation efficiency consideration, the processing window can be set at least comparable to an estimate of the multipath cycle length. The explicit notation for the time index k, where terms are calculated at every measurement epoch is now dropped for convenience. The unbiased CmC signal can be described as a sum of an “approximation” and different “detail” levels of wavelet decomposition as Equation (8). Additionally, an important factor in wavelet analysis is the decomposition level.

$${CmC}_{unbiased} = {a}_{l} + {\sum }_{i = 1}^{l} {d}_{i} \qquad ( 8 )$$

where:
CmC_{unbiased}: unbiased CmC residual [m]
aₗ: approximation at level l, of frequency from 0 to (1/2^{l})*(fₛ/2)Hz
l: the level of wavelet decomposition
dᵢ: detail at level i, of frequency from (1/2ⁱ⁻¹)*(fₛ/2) to (1/2ⁱ)*(fₛ/2)Hz
fₛ=1/Rₛ: sampling frequency of the CmC signal [Hz]
Rₛ: Data sampling interval (i.e., measurement epoch), [s].

For the single-frequency measurement set, this unbiased CmC residual has three major error components: ionosphere error, multipath error, and receiver noise. These three errors are characterized over different frequency ranges. The key of error mitigation using WaveSmooth™ is to select the appropriate detail level (frequency spectrum levels) and window size (i.e., time block), so as to isolate the ionosphere error from the multipath and receiver noise (for our single-frequency user of interest). Therefore, the multipath and receiver noise can be mitigated without introducing significant bias resulting from the ionosphere component. Of the three major error components in the unbiased CmC residual (ionosphere error, multipath error, and receiver noise), the ionosphere error typically has the lowest frequency spectrum. For the single-frequency user, the ionosphere error prediction could be make based upon the broadcast parameters, user position, local time, and SV elevation and azimuth angles. The ionosphere model for GPS can be found with the GPS Interface Control Document (ICD), ICD-GPS-200C, Navstar GPS Space Segment/Navigation User Interface, U.S. Air Force, 10 Oct. 1993, pp. 114-116 and 125-128, http://www.navcen.uscq.gov/pubs/qps/icd200/default.htm, and within the chapter by Klobuchar, John A., Ionospheric Effect on GPS, of the textbook entitled Global Positioning System: Theory and Applications, Vol. 1, B. Parkinson, J. Spilker, P. Axerald and P. Enge (Eds), American Institute of Aeronautics, 1996, pp. 485-515. An approximate rate of the ionosphere change on a daily basis can be gain by using the GPS broadcast ionosphere error model; for a typical day in 2003, this daily ionosphere error frequency spectrum had a maximum values at 5.8e-6 Hz and varies within the range from 0 to 1.2e-4 Hz, which provides an indication of the rate of this ionosphere error component.

The next major error component presented within the unbiased CmC is the multipath error. The fading frequency of the multipath error component desired for removal is estimated, for later removal. A multipath spectral estimation technique is used to provide a multipath frequency spectrum estimation, which is used to bound the frequency domain region for mitigation; either a multipath model or spectral estimation on the GNSS observable data can be accomplished. For ground-based GNSS architectures where the site is in a controlled environment, a multipath model is a good choice. For mobile user applications, a model, or spectral estimation technique can be implemented.

The wavelet analysis is applied to decompose the unbiased CmC for the purpose of error isolation for later mitigation. When receiver measurements are obtained from a single-frequency receiver, a more conservative approach is applied to preserve the ionosphere error, which may be removed in latter processing (i.e., short baseline DGPS architecture). The decomposition level should be at a sufficient level to isolate the anticipated highest rate of the multipath error targeted for removal; typically a detail level from 5 to 8 works well, again, depending on the estimated multipath frequency range. Follow Equation (8) this decomposition generates the approximation and all the details of different levels and frequency components to provide the option of preserving or discard specific frequency component (i.e., details) in a reconstruction (i.e., synthesis) of these error components for later removal.

For illustration purposes, consider a typical ground-based GNSS application. Depending upon antenna height, obstructions in the local area (i.e., the ground), and signal reception elevation angle, a single bounce multipath signal off the earth surface will have a multipath frequency spectrum associated with it. For a sampling frequency of 1 Hz, and antenna height=8.58 ft, the frequency spectral component of the multipath error ranges from about 0.003 to 0.02 Hz, depending upon the SV elevation angle as documented in a paper by Zhang. Y., Bartone, C. G., “Multipath Mitigation in the Frequency Domain,” Proceedings of IEEE Position Location And Navigation Symposium 2004, Sep. 9-12, 2004, Monterey, Calif., ISBN 0-7803-8417-2, © 2004 IEEE, pp. 486-495. When the wavelet decomposition is performed to detail level 8, the frequency rate of the ground multipath is matched to the wavelet detail levels: 5 (i.e., “d₅”) of frequency from 0.016 to 0.031 Hz, 6 (i.e., “d₆”) of frequency from 0.008 to 0.016 Hz, 7 (i.e., “d₇”) of frequency from 0.004 to 0.008 Hz, and 8 (i.e., “d₈”) of frequency from 0.002 to 0.004 Hz. This illustrates that the multipath error can be isolated, at the detail level, in the wavelet decomposition of the unbiased CmC residual. Note that the level needed to be taken (e.g., detail level 8 here) should be high enough to capture (i.e., isolate) the frequency component of the error term targeted for isolation, and no further. It should be noted that the level selection is dependent on the sampling rate, antenna height, obstruction environment, and to a limited extent, the smoothing window size.

Additionally, the processing window (time constant τ) is set to be comparable to or greater than the anticipated multipath fading cycle, so that the multipath frequency component can be effectively exposed in the wavelet decomposed details (e.g., d₅ through d₈). A longer processing window size (in the time-domain) is preferred for the best error mitigation; however, the window size needs to be limited for computation efficiency consideration. A good tradeoff is to set the processing window to be about one to three times the maximum anticipated multipath cycle, when multipath is the main error source targeted for mitigation. The knowledge of the multipath cycle can be retrieved from the multipath model; for ground based applications, this can be predicted as a function of the antenna height, SV elevation angle, reflection coefficient, code correlator spacing, etc.

The last major error component in the unbiased CmC is the receiver noise. Since the receiver noise spectrum is roughly Gaussian distributed, a wavelet decomposition at a detail level “l” will decompose and isolate the receiver noise, in the detail level(s), by a factor of 1-2^{-l}. For example a wavelet decomposition at a detail level of: 1 will represent 50% of the noise in the detail; 2 will represent 75% of the noise in the details; and 3 will represent 87.5% of the noise in the details, and so on.

With the decomposition and error isolation complete, the next step is to reconstruct (i.e., synthesize) a “smoothed error estimation” from the unbiased CmC signal, which will be targeted for removal from the code phase measurement. For single-frequency users, which choose to have the ionosphere error term largely unaffected by the WaveSmooth™ technique, this smoothed error estimation is formed in accordance with Equations (9) and (10). The reconstruction of the low frequency component shown in Equation (5) including ionosphere propagation error, from the approximation at level “l” essentially discard the multipath and receiver noise contained in the details from level d₁ to level dₗ.
\hat{ε}_{low}=αₗ (9)

When the low frequency component, shown in Equation (9), is subtracted from the unbiased CmC signal, see Equation (10), the final WaveSmooth™ error estimation is formed for the single-frequency user.
\hat{ε}_{WaveSmooth}=CmC_{unbiased}−\hat{ε}_{low} (10)

For multi-frequency GNSS users, the reconstructed “smoothed error estimation” is largely the multipath error estimation. The optimum synergy of spectrogram decomposition and the CmC provides for high fidelity multipath estimation. Specifically, the multipath estimation is the low frequency component directly from the approximation at level “l”, as shown in Equation (11).
\hat{ε}_{WaveSmooth}=\hat{ε}_{low}=αₗ (11)

Step 3 Error Mitigation. The real-time WaveSmooth™ error estimation from Equation (10) for single-frequency GNSS users, or Equation (11) for dual-frequency (i.e., iono-free) GNSS users is subtracted from to the code phase measurement to mitigate code phase measurement error as shown in Equation (12).
\hat{ρ}_{WaveSmooth}=ρ−\hat{ε}_{WaveSmooth} (12)

This WaveSmooth™ error mitigated pseudorange measurement can be used, along with the original carrier phase measurement for a high performance user solution. Additionally, since the WaveSmooth™ technique introduces negligible recursive delay lag, a second iteration can be conducted to achieve better smoothing result.

1. WaveSmooth™ is a group of techniques that utilizes wavelet aided methods and operate on the Code minus Carrier (CmC) signal to mitigate inherent GNSS measurement errors in a real-time fashion to improve the performance of these GNSS.

2. A method according to claim 1 wherein said “wavelet aided methods” refer to all the GNSS error mitigation methods aided by wavelet techniques in an optimum state of art to mitigate inherent GNSS measurement error.

3. A method according to claim 1 wherein said “wavelet aided methods” refer to all the GNSS error mitigation methods aided by wavelet techniques utilizes spectrogram analysis to provide a time resolution representation of the multipath error component, and offers the unique ability to analyze the error characteristics at different frequencies and to localize them in time.

4. A method according to claim 1 wherein said “group of techniques that” and “operate on the Code minus Carrier (CmC) signal” and “real-time fashion” covers removal of the bias in the CmC signal in real-time to enable enhanced performance of the GNSS.

5. A method according to claim 1 wherein said “inherent measurement errors” covers all the possible error components inherent in a GNSS including receiver noise, multipath, atmospheric error, environmental error, ionospheric delay, temperature error, spatial error, temporal error, etc.

6. A method according to claim 1 wherein said “performance” is in terms of complexity, cost real-time, position, velocity, time, accuracy, reliability, integrity, availability and continuity, etc.

7. A method according to claim 1 wherein said “improved performance” is gained for whereby minimal recursive lag is introduced in the smoothing process, thus minimizes risk when the ionosphere error is not the same at each end of the baseline in DGPS architectures.

8. A method according to claim 1 wherein said “improved performance” is obtained whereby the WaveSmooth™ technique can be implemented in real-time for GNSS architectures.
